(19) United States
(12) Patent Application Publication
(10) Pub. No.: US 2012/0129708 A1
(43) Pub. Date: May 24, 2012

(54) COMPOSITIONS AND METHODS FOR PREDICTING CARDIOVASCULAR EVENTS

(75) Inventors: Bradley Bale, Hendersonville, TN (US); Amy L. Doneen, Spokane, WA (US); Jacob Orville, Shaker Heights, OH (US)

(73) Assignee: CLEVELAND HEART LAB, Cleveland, OH (US)

(21) Appl. No.: 13/111,805

(22) Filed: May 19, 2011

Related U.S. Application Data
(60) Provisional application No. 61/346,265, filed on May 19, 2010.

(51) Int. Cl. C40B 30/04; C40B 40/00

(52) U.S. Cl. 506/9; 506/13

(57) ABSTRACT

The present invention provides methods, systems, devices, panels, and software for determining values for two or more markers in order to characterize a subject's risk of developing cardiovascular disease or experiencing a complication thereof (e.g., within the ensuing one to three years), and for identifying subjects in need of preventative therapy (e.g., statins). In certain embodiments, the markers are selected from: hs-CRP, ACR, Lp-Pla2, MPO, fibrinogen, KIF6, and F2 isoprostanes.

The present application claims priority to U.S. Provisional application 61/346,265 filed May 19, 2010, which is herein incorporated by reference in its entirety.

### FIELD OF THE INVENTION

The present invention provides methods, systems, devices, panels, and software for determining values for three or more markers in order to characterize a subject's risk of developing cardiovascular disease or experiencing a complication thereof, and for identifying subjects in need of preventative therapy (e.g., statins). In certain embodiments, the markers are selected from: hs-CRP, ACR, Lp-Pla2, MPO, fibrinogen, KIF6, and F2 isoprostanes.

### BACKGROUND

Cardiovascular disease (CVD) is the leading cause of death in the United States, with more than 600,000 coronary heart disease (CHD) deaths occurring annually. Every 26 seconds, an American will suffer a coronary event, and about every minute, someone will die from one. It's sobering to realize that 67 percent of patients who survive a heart attack never make a complete recovery. Tragically, 20 percent will develop heart failure within six years.

Stroke, a major form of CVD, is the third leading cause of death in the United States. Every 40 seconds, someone in America has a stroke. On average, about every three minutes, someone dies from a stroke. Approximately 83 percent of all strokes, classified as ischemic, are caused by inadequate supply of blood to the brain. Strokes are the biggest cause of disability in the United States and exact a financial toll from our health care system. Combined, heart disease and stroke cost the United States more than $220 billion annually.

Several factors increase a person's risk of a heart attack and stroke, including high cholesterol, high blood pressure, obesity, diabetes, smoking and physical inactivity. The more risk factors a person has, the greater the risk of having a heart attack or stroke. Some risk factors are inherent and cannot be changed, such as increasing age, family history and gender. Several risk factors, however, can be addressed with lifestyle changes, such as exercise and diet, as well as medication.

While risk factor identification remains one of the most important approaches to preventing CVD, traditional risk factors lack the precision to identify many people with hidden CVD risk. Approximately 50 percent of all coronary events strike people with low to moderate cholesterol levels, and about 20 percent occur in people with none of the four major risk factors (high cholesterol, high blood pressure, smoking or diabetes). Therefore, hidden CVD is prevalent, and a critical need exists to identify all at-risk patients.

Most heart attacks and strokes occur when a blood clot forms in an artery, cutting off the blood supply to the affected tissue. Blood clots frequently occur when soft plaque in an artery ruptures. Part of the CVD disease process involves inflammation of the artery. Inflammation may be involved with all stages of this disease from its inception to the culmination in a vascular event, such as a heart attack or stroke.

Because traditional methods for predicting heart attacks and strokes, such as cholesterol levels and stress tests, often miss many people who go on to have cardiovascular (CV) events, what is needed are compositions and methods that identify more people at risk.

### SUMMARY OF THE INVENTION

The present invention provides methods, systems, devices, panels, and software for determining values for two or more markers in order to characterize a subject's risk of developing cardiovascular disease or experiencing a complication thereof (e.g., within the ensuing one to three years), and for identifying subjects in need of preventative therapy (e.g., statins or other CVD therapeutic agent). In certain embodiments, the markers are selected from: hs-CRP, ACR, Lp-Pla2, MPO, fibrinogen, KIF6, and F2 isoprostanes.

In some embodiments, the present invention provides multiplex panels or kits, comprising or consisting of: reagents for detecting levels or activity of three or more markers selected from the group consisting of: microalbumin-creatinine ratio (ACR) (e.g., human ACR), hs-CRP (e.g., human hs-CRP), Lp-PLA2 (e.g., human Lp-PLA2), an F2-isoprostane (e.g., a human F2-isoprostane), and myeloperoxidase (e.g., human myeloperoxidase). In certain embodiments, the panels or kits further comprise reagents for detecting fibrinogen. In other embodiments, the panels kits further comprise reagents for detecting KIF6. In additional embodiments, the panels or kits comprise reagents for detecting levels or activity of four or more of the markers. In particular embodiments, the kits or panels comprise (or consist of) reagents for detecting levels or activity of all of the markers. In some embodiments, the kits or panels comprise or consist of reagents for detecting levels or activity of microalbumin-creatinine ratio (ACR) (e.g., reagents for detecting albumin and creatine), hs-CRP, Lp-PLA2 and myeloperoxidase. In further embodiments, the markers are polypeptides and the reagent comprises reagents for detecting levels or activity of the polypeptides.

In some embodiments, the present invention provides methods for determining risk of a cardiovascular event or complication of a cardiovascular event in a subject, comprising: a) measuring, in a sample from the subject, the levels or activity of three or more markers selected from the group consisting of microalbumin-creatinine ratio (ACR), fibrinogen, hs-CRP, and myeloperoxidase in a sample from a subject; and b) determining an increased risk of a cardiac event, or complication of a cardiovascular event, in the subject when levels or activity of one or more of the markers are elevated. In certain embodiments, the subject is apparently healthy and is nonetheless identified as having an increased risk of a cardiac event or a complication of a cardiovascular event.

In some embodiments, the determining an increased risk is found when the levels or activity or two or more, or three or more, or four or more, or five of said markers are elevated. In particular embodiments, the methods further comprise the step of administering a statin (or other CVD therapeutic agent) to subjects identified as having an increased risk of a cardiac event. In further embodiments, the level or activity of the three or more markers is compared to a threshold control value for each of the three of more markers. In certain embodiments, the methods further comprise measuring levels or activity of fibrinogen (e.g., human fibrinogen). In particular embodiments, the methods further comprise measuring levels or activity of KIF6. In additional embodiments, the methods comprise measuring activity or levels of four or more of the markers. In some embodiments, the methods comprise measuring activity or levels of all of the markers. In particular embodiments, the methods comprise measuring activity or levels of microalbumin-creatinine ratio (ACR), hs-CRP, Lp-PLA2 and myeloperoxidase.

In some embodiments, the markers are polypeptides and the measuring comprises detecting levels or activity of the polypeptides. In further embodiments, the sample comprises blood and/or urine and/or any other biological fluid. In other embodiments, the complication is one or more of the following: non-fatal myocardial infarction, stroke, angina pectoris, transient ischemic attacks, congestive heart failure, aortic aneurysm, aortic dissection, and death. In certain embodiments, the determining comprising providing the level or values of the three or more markers to a computer processor (e.g., running a computer program) configured to determine the risk of a cardiac event or complication of a cardiovascular event.

### DEFINITIONS

As used herein, the terms “cardiovascular disease” (CVD) or “cardiovascular disorder” are terms used to classify numerous conditions affecting the heart, heart valves, and vasculature (e.g., veins and arteries) of the body and encompasses diseases and conditions including, but not limited to arteriosclerosis, atherosclerosis, myocardial infarction, acute coronary syndrome, angina, congestive heart failure, aortic aneurysm, aortic dissection, iliac or femoral aneurysm, pulmonary embolism, primary hypertension, atrial fibrillation, stroke, transient ischemic attack, systolic dysfunction, diastolic dysfunction, myocarditis, atrial tachycardia, ventricular fibrillation, endocarditis, arteriopathy, vasculitis, atherosclerotic plaque, vulnerable plaque, acute coronary syndrome, acute ischemic attack, sudden cardiac death, peripheral vascular disease, coronary artery disease (CAD), peripheral artery disease (PAD), and cerebrovascular disease. The combination of markers of the present invention may be used to identify the risk of any one or collection of these specific conditions.

As used herein, the term “atherosclerotic cardiovascular disease” or “disorder” refers to a subset of cardiovascular disease that include atherosclerosis as a component or precursor to the particular type of cardiovascular disease and includes, without limitation, CAD, PAD, cerebrovascular disease. Atherosclerosis is a chronic inflammatory response that occurs in the walls of arterial blood vessels. It involves the formation of atheromatous plaques that can lead to narrowing (“stenosis”) of the artery, and can eventually lead to partial or complete closure of the arterial opening and/or plaque ruptures. Thus atherosclerotic diseases or disorders include the consequences of atheromatous plaque formation and rupture including, without limitation, stenosis or narrowing of arteries, heart failure, aneurysm formation including aortic aneurysm, aortic dissection, and ischemic events such as myocardial infarction and stroke

A cardiovascular event, as used herein, refers to the manifestation of an adverse condition in a subject brought on by cardiovascular disease, such as sudden cardiac death or acute coronary syndromes including, but not limited to, myocardial infarction, unstable angina, aneurysm, or stroke. The term “cardiovascular event” can be used interchangeably herein with the term cardiovascular complication. While a cardiovascular event can be an acute condition, it can also represent the worsening of a previously detected condition to a point where it represents a significant threat to the health of the subject, such as the enlargement of a previously known aneurysm or the increase of hypertension to life threatening levels.

As used herein, the term “diagnosis” can encompass determining the nature of disease in a subject, as well as determining the severity and probable outcome of disease or episode of disease and/or prospect of recovery (prognosis). “Diagnosis” can also encompass diagnosis in the context of rational therapy, in which the diagnosis guides therapy, including initial selection of therapy, modification of therapy (e.g., adjustment of dose and/or dosage regimen or lifestyle change recommendations), and the like.

The terms “individual,” “host,” “subject,” and “patient” are used interchangeably herein, and generally refer to a mammal, including, but not limited to, primates, including simians and humans, equines (e.g., horses), canines (e.g., dogs), felines, various domesticated livestock (e.g., ungulates, such as swine, pigs, goats, sheep, and the like), as well as domesticated pets and animals maintained in zoos. In some embodiments, the subject is specifically a human subject.

As used herein, the terms “computer memory” and “computer memory device” refer to any storage media readable by a computer processor. Examples of computer memory include, but are not limited to, RAM, ROM, computer chips, digital video disc (DVDs), compact discs (CDs), hard disk drives (HDD), flash drives, and magnetic tape.

As used herein, the term “computer readable medium” refers to any device or system for storing and providing information (e.g., data and instructions) to a computer processor. Examples of computer readable media include, but are not limited to, DVDs, CDs, hard disk drives, flash drives, magnetic tape and servers for streaming media over networks.

As used herein, the terms “computer processor” and “central processing unit” or “CPU” are used interchangeably and refers to a device that is able to read a program from a computer memory (e.g., ROM or other computer memory) and perform a set of steps according to the program.

Before the present invention is further described, it is to be understood that this invention is not limited to particular embodiments described, as such may, of course, vary. It is also to be understood that the terminology used herein is for the purpose of describing particular embodiments only, and is not intended to be limiting.

### DESCRIPTION OF THE INVENTION

The present invention provides methods, systems, devices, panels, and software for determining values for two or more markers in order to characterize a subject's risk of developing cardiovascular disease or experiencing a complication thereof (e.g., within the ensuing one to three years), and for identifying subjects in need of preventative therapy (e.g., statins). In certain embodiments, the markers are selected from: hs-CRP, ACR, Lp-Pla2, MPO, fibrinogen, KIF6, and F2 isoprostanes.

Accordingly, in some embodiments, the present invention provides compositions and methods for predicting cardiovascular events. In some embodiments, the present invention provides a panel of markers specifically linked to inflammation making it easier to predict acute risk of events. Thus, in some embodiments, a treatment course of action can be determined based on an individual's risk assessment. For example, in some embodiments, additional diagnostics (e.g., angioplasty) or preventative treatment (e.g., statin therapy) can be provided to subjects at increased risk of cardiac events.

### I. Markers and Combinations of Markers

The present invention is not limited to any particular marker or panel of markers. In certain embodiments, the markers employed include at least two, or three, or four, or five or six of the following: hs-CRP, ACR, Lp-Pla2, MPO, fibrinogen, KIF6, and F2 isoprostanes. In certain embodiments, standard markers are further employed with the markers herein in, such as: smoking status, age, gender, history of hypertension, diabetes mellitus status, fasting glucose level, creatine level, potassium level, total cholesterol level, LDL cholesterol level, HDL cholesterol level, triglycerides level, systolic blood pressure, diastolic blood pressure, body mass index, aspirin use, statin use, and history of cardiovascular disease. Any and all combinations of the seven markers describes above and the standard markers above are conemplated.

Microalbumin-creatinine ratio (ACR) is the ratio of albumin to creatine ratio in a sample (see, e.g., Bakker, Diabetes Care. 1999 February;22(2):307-13, herein incorporated by refernece). ACR can be determined, for example, by a simple and inexpensive urine test. ACR is frequently measured routinely to assess CV risk (Solomon et al., Circulation, 2007 Dec. 4;116(23):2687-93; herein incorporated by reference). In the Framingham Study, which looked at CV risk, numerous biomarkers were measured. When an analysis was done to see which biomarkers independently predicted CV risk, only two measurements qualified. One of those was the ACR (Wang T J, et al. N Engl J Med., 2006; 355:2631-2639; herein incorporated by reference in its entirety). It is noted, however, that ACR can increase with chronic kidney disease without the individual necessarily being at increased risk for a cardiovascular event (see, e.g., Foster M C et al. Arch Intern Med., 2007; 167:1386-1392, herein incorporated by reference). In certain embodiments, the panel, kits, and methods of the present invention include reagents for detecting albumin (e.g., human albumin) and creatinine (e.g., human creatinine) such that a ration between these two can be established.

Fibrinogen is an indicator of inflammation as well. Fibrinogen has been shown to predict the risk of cardiovascular events (see, e.g., Ridker et al., Circulation, July 2004 6;109 (25 Suppl. 1); Danesh et al., JAMA, October 2005, Vol 294, No. 14:1799-1809; and Hartmann et al., J. Am. Coll. Cardiol., July 2006;48:446-452; all of which are herein incorporated by reference). However, many factors other than arterial inflammation can affect the levels, rendering it unreliable as a sole test of vascular inflammation. As such, in some embodiments, Fibrinogen is part of the panels of the present invention.

Highly sensitive C-reactive protein (hs-CRP) is elevated with inflammation. While hs-CRP is a good test to identify inflammation in the body, the measure frequently cannot identify inflammation that's specific to just the arteries. Factors, such as periodontal (gum) disease, infection and arthritis, will elevate the hs-CRP level. Therefore, hs-CRP cannot be relied upon as a definite indicator of increased CV risk when used alone. Both fibrinogen and hs-CRP were measured in the Framingham Study, and neither independently predicted CV risk (Wang et al., supra).

Lipoprotein-associated phospholipase A2 (Lp-PLA2) is a cardiovascular-specific inflammatory enzyme implicated in the formation of vulnerable, rupture-prone plaque. In the blood, Lp-PLA2 associates primarily with low-density lipoprotein (LDL, the “bad” cholesterol). Lp-PLA2 is carried to the walls of coronary arteries by LDL, where the enzyme can activate an inflammatory response, making plaque more prone to rupture. In more than 65 studies, Lp-PLA2 was linked to CV risk. It was FDA-approved for coronary heart disease risk assessment in 2003 and for ischemic stroke risk assessment in 2005. It is now the only blood test approved to assess stroke risk. Lp-PLA2 is also now found in guidelines from the American College of Cardiology Foundation, American Heart Association and the American Stroke Association, Greenland, P., et. al. Journal of the American College of Cardiology Vol. 56, No. 25, 2010, herein incorporated by reference.

Myeloperoxidase (MPO) is an evolving inflammatory marker, which has recently gained FDA approval for clinical use in people experiencing acute chest pain. Substantial evidence shows that an elevated level of MPO in patients with chest pain is a strong indication of unstable coronary artery disease. When it's high, a much greater risk for heart attack exists immediately and throughout the next six months. It's an enzyme that can stimulate vascular inflammation and death of endothelial cells. Mounting evidence suggests that MPO may be involved in all stages of atherosclerosis.

KIF6. In some embodiments, KIF6 gene status is assessed. The KIF6 test is a genetic test related to a person's response to statin drugs to reduce CV event risk. If someone is a noncarrier, he would not get a good response to mono-statin therapy for preventing CV events.

F2 Isoprostanes. F2-isoprostanes are prostaglandin-like compounds formed via arachidonic acid oxidation during oxidative stress. It has been found, for example, that women with high levels of urinary 8-iso PGF2α have an increased risk of dying of coronary heart disease or stroke (see, Roest et al., Journal of Clinical Lipidology Volume 2, Issue 4, Pages 298-303, August 2008, herein incorporated by reference).

The present invention is not limited to a particular mechanism. Indeed, an understanding of the mechanism is not necessary to practice the present invention. Nonetheless, from the standpoint of reliable risk assessment, specific combinations of markers provide enhanced information and used alone or in combination with non-inflammatory markers, provide an unexpected and unprecedented ability to manage CVD.

As described in the case studies below (see Example 1), traditional methods for detecting CV risk fail to identify many people who have a heart attack or stroke and thus are good candidates for statin therapy or other type of cardiovascular intervention.

Accordingly, in some embodiments, the present invention provides compositions and methods for assessing cardiac risk. In some embodiments, panels and kits that measure the level of 3 or more (e.g., 4 or more) of microalbumin-creatinine ratio (ACR), hs-CRP, Lp-PLA2 and myeloperoxidase. In some embodiments, levels of F2-isoprostanes and/or fibrinogen are also measured. In some embodiments, increased levels of one or more of the above named markers are associated with increased risk of cardiovascular events.

### II. Measuring Maker Levels

Embodiments of the present invention further provide compositions, systems (e.g., high throughput systems), kits, arrays, panels, etc. for measuring expression levels of the above named markers. The markers of the present invention can be detected in any suitable manner. Methods for detecting the level and/or activity of these markers are known in the art.

In some embodiments, markers are detected in urine or serum, although the invention is not limited to the nature of the sample used. Any patient sample may be tested according to the methods of the present invention. By way of non-limiting examples, the sample may be tissue, blood, urine, semen, or a fraction thereof (e.g., plasma, serum, urine supernatant, urine cell pellet, etc.). In some embodiments, the patient sample is processed prior to assaying for the marker to isolate or enrich the sample for the markers described herein. A variety of techniques known to those of ordinary skill in the art may be used for this purpose, including but not limited: centrifugation; immunocapture; cell lysis; and, nucleic acid target capture.

In some embodiments, markers are detected in a multiplex or panel format. In some embodiments, the assays detect quantitative levels of marker polypeptide. In some embodiments, panels, assay kits and/or methods comprise reagents and methods for detecting a panel of markers comprising or consisting of two or more of microalbumin-creatinine ratio (ACR), fibrinogen, hs-CRP, Lp-PLA2, F2-isoprostanes and myeloperoxidase.

In some embodiments, assays are conducted before during, or after a medical procedure (e.g., surgery, drug regimen, etc.). In some embodiments, result of the assay is used to select appropriate intervention, modify intervention (e.g., drug selection, dose, timing, addition or omission of additional diagnostic or other medical test or procedures, etc.), and test/assess the intervention.

Any suitable detection assay may be utilized in the methods described herein. Illustrative non-limiting examples of protein detection methods include protein sequencing/analysis and immunoassays.

Protein sequencing techniques/analysis include, but are not limited to, mass spectrometry and Edman degradation.

Illustrative non-limiting examples of immunoassays include, but are not limited to: immunoprecipitation; Western blot; ELISA; immunohistochemistry; immunocytochemistry; flow cytometry; and, immuno-PCR. Polyclonal or monoclonal antibodies detectably labeled using various techniques known to those of ordinary skill in the art (e.g., colorimetric, fluorescent, chemiluminescent or radioactive) are suitable for use in the immunoassays.

Immunoprecipitation is the technique of precipitating an antigen out of solution using an antibody specific to that antigen. The process can be used to identify protein complexes present in cell extracts by targeting a protein believed to be in the complex. The complexes are brought out of solution by insoluble antibody-binding proteins isolated initially from bacteria, such as Protein A and Protein G. The antibodies can also be coupled to sepharose beads that can easily be isolated out of solution. After washing, the precipitate can be analyzed using mass spectrometry, Western blotting, or any number of other methods for identifying constituents in the complex.

A Western blot, or immunoblot, is a method to detect protein in a given sample of tissue homogenate or extract. It uses gel electrophoresis to separate denatured proteins by mass. The proteins are then transferred out of the gel and onto a membrane, typically polyvinyldiflroride or nitrocellulose, where they are probed using antibodies specific to the protein of interest. As a result, researchers can examine the amount of protein in a given sample and compare levels between several groups.

An ELISA, short for Enzyme-Linked ImmunoSorbent Assay, is a biochemical technique to detect the presence of an antibody or an antigen in a sample. It utilizes a minimum of two antibodies, one of which is specific to the antigen and the other of which is coupled to an enzyme. The second antibody will cause a chromogenic or fluorogenic substrate to produce a signal. Variations of ELISA include sandwich ELISA, competitive ELISA, and ELISPOT. Because the ELISA can be performed to evaluate either the presence of antigen or the presence of antibody in a sample, it is a useful tool both for determining serum antibody concentrations and also for detecting the presence of antigen.

Immunohistochemistry and immunocytochemistry refer to the process of localizing proteins in a tissue section or cell, respectively, via the principle of antigens in tissue or cells binding to their respective antibodies. Visualization is enabled by tagging the antibody with color producing or fluorescent tags. Typical examples of color tags include, but are not limited to, horseradish peroxidase and alkaline phosphatase. Typical examples of fluorophore tags include, but are not limited to, fluorescein isothiocyanate (FITC) or phycoerythrin (PE).

Flow cytometry is a technique for counting, examining and sorting microscopic particles suspended in a stream of fluid. It allows simultaneous multiparametric analysis of the physical and/or chemical characteristics of single cells flowing through an optical/electronic detection apparatus. A beam of light (e.g., a laser) of a single frequency or color is directed onto a hydrodynamically focused stream of fluid. A number of detectors are aimed at the point where the stream passes through the light beam; one in line with the light beam (Forward Scatter or FSC) and several perpendicular to it (Side Scatter (SSC) and one or more fluorescent detectors). Each suspended particle passing through the beam scatters the light in some way, and fluorescent chemicals in the particle may be excited into emitting light at a lower frequency than the light source. The combination of scattered and fluorescent light is picked up by the detectors, and by analyzing fluctuations in brightness at each detector, one for each fluorescent emission peak, it is possible to deduce various facts about the physical and chemical structure of each individual particle. FSC correlates with the cell volume and SSC correlates with the density or inner complexity of the particle (e.g., shape of the nucleus, the amount and type of cytoplasmic granules or the membrane roughness).

In certain embodiments, one or more of the markers are analyzed by a blood analyzer configured to detect one or more of the markers described herein (e.g., MPO is analyzed by a blood analyzer). In particular embodiments, the analyzers are hematology analyzers (e.g., configured for detecting MPO).

A hematology analyzer (a.k.a. haematology analyzer, hematology analyzer, haematology analyser) is an automated instrument (e.g. clinical instrument and/or laboratory instrument) which analyzes the various components (e.g. blood cells) of a blood sample. Typically, hematology analyzers are automated cell counters used to perform cell counting and separation tasks including: differentiation of individual blood cells, counting blood cells, separating blood cells in a sample based on cell-type, quantifying one or more specific types of blood cells, and/or quantifying the size of the blood cells in a sample. In some embodiments, hematology analyzers are automated coagulometers which measure the ability of blood to clot (e.g. partial thromboplastin times, prothrombin times, lupus anticoagulant screens, D dimer assays, factor assays, etc.), or automatic erythrocyte sedimentation rate (ESR) analyzers. In general, a hematology analyzer performing cell counting functions samples the blood, and quantifies, classifies, and describes cell populations using both electrical and optical techniques. A properly outfitted hematology analyzer (e.g. with peroxidase staining capability) is capable of providing values for a marker, such as MPO, using various analyses.

Electrical analysis by a hematology analyzer generally involves passing a dilute solution of a blood sample through an aperture across which an electrical current is flowing. The passage of cells through the current changes the impedance between the terminals (the Coulter principle). A lytic reagent is added to the blood solution to selectively lyse red blood cells (RBCs), leaving only white blood cells (WBCs), and platelets intact. Then the solution is passed through a second detector. This allows the counts of RBCs, WBCs, and platelets to be obtained. The platelet count is easily separated from the WBC count by the smaller impedance spikes they produce in the detector due to their lower cell volumes.

Optical detection by a hematology analyzer may be utilized to gain a differential count of the populations of white cell types. In general, a suspension of cells (e.g. dilute cell suspension) is passed through a flow cell, which passes cells one at a time through a capillary tube past a laser beam. The reflectance, transmission, and scattering of light from each cell are analyzed by software giving a numerical representation of the likely overall distribution of cell populations.

### III. Computer Processing

In some embodiments, a computer-based analysis program is used to translate the raw data generated by the detection assay (e.g., the presence, absence, activity, or amount of a given marker) into data of predictive value for a clinician. The clinician can access the predictive data using any suitable means. Thus, in some preferred embodiments, the present invention provides the further benefit that the clinician, who is not likely to be trained in genetics or molecular biology, need not understand the raw data. The data is presented directly to the clinician in its most useful form. The clinician is then able to immediately utilize the information in order to optimize the care of the subject.

The present invention contemplates any method capable of receiving, processing, and transmitting the information to and from laboratories conducting the assays, information provides, medical personal, and subjects. For example, in some embodiments of the present invention, a sample (e.g., a biopsy or a serum or urine sample) is obtained from a subject and submitted to a profiling service (e.g., clinical lab at a medical facility, genomic profiling business, etc.), located in any part of the world (e.g., in a country different than the country where the subject resides or where the information is ultimately used) to generate raw data. Where the sample comprises a tissue or other biological sample, the subject may visit a medical center to have the sample obtained and sent to the profiling center, or subjects may collect the sample themselves (e.g., a urine sample) and directly send it to a profiling center. Where the sample comprises previously determined biological information, the information may be directly sent to the profiling service by the subject (e.g., an information card containing the information may be scanned by a computer and the data transmitted to a computer of the profiling center using an electronic communication systems). Once received by the profiling service, the sample is processed and a profile is produced (i.e., expression data), specific for the diagnostic or prognostic information desired for the subject.

The profile data is then prepared in a format suitable for interpretation by a treating clinician. For example, rather than providing raw expression data, the prepared format may represent a diagnosis or risk assessment (e.g., risk of cardiovascular events) for the subject, along with recommendations for particular treatment options. The data may be displayed to the clinician by any suitable method. For example, in some embodiments, the profiling service generates a report that can be printed for the clinician (e.g., at the point of care) or displayed to the clinician on a computer monitor.

In some embodiments, the information is first analyzed at the point of care or at a regional facility. The raw data is then sent to a central processing facility for further analysis and/or to convert the raw data to information useful for a clinician or patient. The central processing facility provides the advantage of privacy (all data is stored in a central facility with uniform security protocols), speed, and uniformity of data analysis. The central processing facility can then control the fate of the data following treatment of the subject. For example, using an electronic communication system, the central facility can provide data to the clinician, the subject, or researchers.

In some embodiments, the subject is able to directly access the data using the electronic communication system. The subject may chose further intervention or counseling based on the results. In some embodiments, the data is used for research use. For example, the data may be used to further optimize the inclusion or elimination of markers as useful indicators of a particular condition or stage of disease.

### IV. Biological Samples

Biological samples include, but are not necessarily limited to bodily fluids such as blood-related samples (e.g., whole blood, serum, plasma, and other blood-derived samples), urine, cerebral spinal fluid, bronchoalveolar lavage, and the like. Another example of a biological sample is a tissue sample.

A biological sample may be fresh or stored (e.g. blood or blood fraction stored in a blood bank). The biological sample may be a bodily fluid expressly obtained for the assays of this invention or a bodily fluid obtained for another purpose which can be sub-sampled for the assays of this invention.

In one embodiment, the biological sample comprises whole blood. Whole blood may be obtained from the subject using standard clinical procedures. In another embodiment, the biological sample is plasma. Plasma may be obtained from whole blood samples by centrifugation of anti-coagulated blood. Such process provides a buffy coat of white cell components and a supernatant of the plasma. In another embodiment, the biological sample is serum. Serum may be obtained by centrifugation of whole blood samples that have been collected in tubes that are free of anti-coagulant. The blood is permitted to clot prior to centrifugation. The yellowish-reddish fluid that is obtained by centrifugation is the serum. In another embodiment, the sample is urine.

The sample may be pretreated as necessary by dilution in an appropriate buffer solution, heparinized, concentrated if desired, or fractionated by any number of methods including but not limited to ultracentrifugation, fractionation by fast performance liquid chromatography (FPLC), or precipitation of apolipoprotein B containing proteins with dextran sulfate or other methods. Any of a number of standard aqueous buffer solutions at physiological pH, such as phosphate, Tris, or the like, can be used.

### V. Subjects

In certain embodiments, the subject is any human or other animal to be tested for characterizing its risk of CVD (e.g. congestive heart failure, aortic aneurysm or aortic dissection). In certain embodiments, the subject does not otherwise have an elevated risk of an adverse cardiovascular event. Subjects having an elevated risk of experiencing a cardiovascular event include those with a family history of cardiovascular disease, elevated lipids, smokers, prior acute cardiovascular event, etc. (See, e.g., Harrison's Principles of Experimental Medicine, 15th Edition, McGraw-Hill, Inc., N.Y., hereinafter “Harrison's,” which is herein incorporated by reference).

In certain embodiments the subject is apparently healthy. “Apparently healthy,” as used herein, describes a subject who does not have any signs or symptoms of CVD or has not previously been diagnosed as having any signs or symptoms indicating the presence of atherosclerosis, such as angina pectoris, history of a cardiovascular event such as a myocardial infarction or stroke, or evidence of atherosclerosis by diagnostic imaging methods including, but not limited to coronary angiography. Apparently healthy subjects also do not have any signs or symptoms of having heart failure or an aortic disorder.

In other embodiments, the subject already exhibits symptoms of cardiovascular disease. For example, the subject may exhibit symptoms of heart failure or an aortic disorder such as aortic dissection or aortic aneurysm. For subjects already experiencing cardiovascular disease, the values for the markers of the present invention can be used to predict the likelihood of further cardiovascular events or the outcome of ongoing cardiovascular disease.

In certain embodiments, the subject is a nonsmoker. “Nonsmoker” describes an individual who, at the time of the evaluation, is not a smoker. This includes individuals who have never smoked as well as individuals who have smoked but have not used tobacco products within the past year. In certain embodiments, the subject is a smoker.

In some embodiments, the subject is a nonhyperlipidemic subject. “Nonhyperlipidemic” describes a subject that is a nonhypercholesterolemic and/or a nonhypertriglyceridemic subject. A “nonhypercholesterolemic” subject is one that does not fit the current criteria established for a hypercholesterolemic subject. A nonhypertriglyceridemic subject is one that does not fit the current criteria established for a hypertriglyceridemic subject (See, e.g., Harrison's). Hypercholesterolemic subjects and hypertriglyceridemic subjects are associated with increased incidence of premature coronary heart disease. A hypercholesterolemic subject has an LDL level of >160 mg/dL, or >130 mg/dL and at least two risk factors selected from the group consisting of male gender, family history of premature coronary heart disease, cigarette smoking (more than 10 per day), hypertension, low HDL (<35 mg/dL), diabetes mellitus, hyperinsulinemia, abdominal obesity, high lipoprotein (a), and personal history of cerebrovascular disease or occlusive peripheral vascular disease. A hypertriglyceridemic subject has a triglyceride (TG) level of >250 mg/dL. Thus, a nonhyperlipidemic subject is defined as one whose cholesterol and triglyceride levels are below the limits set as described above for both the hypercholesterolemic and hypertriglyceridemic subjects.

### VI. Threshold Control Values

In certain embodiments, values of the markers of the present invention in the biological sample obtained from the subject may compared to a threshold control value. A threshold control value is a concentration or number or activity of a marker that represents a known or representative amount of the marker. For example, the threshold control value can be based upon values of certain markers in comparable samples obtained from a reference cohort. In certain embodiments, the reference cohort is the general population. In certain embodiments, the reference cohort is a select population of human subjects. In certain embodiments, the reference cohort is comprised of individuals who have not previously had any signs or symptoms indicating the presence of atherosclerosis, such as angina pectoris, history of a cardiovascular event such as a myocardial infarction or stroke, evidence of atherosclerosis by diagnostic imaging methods including, but not limited to coronary angiography. In certain embodiments, the reference cohort includes individuals, who if examined by a medical professional would be characterized as free of symptoms of disease (e.g., cardiovascular disease). In another example, the reference cohort may be individuals who are nonsmokers (i.e., individuals who do not smoke cigarettes or related items such as cigars). The threshold control values selected may take into account the category into which the test subject falls. Appropriate categories can be selected with no more than routine experimentation by those of ordinary skill in the art. The threshold control value is preferably measured using the same units used to measures one or more markers of the present invention.

The threshold value can take a variety of forms. The threshold value can be a single cut-off value, such as a median or mean. The control value can be established based upon comparative groups such as where the risk in one defined group is double the risk in another defined group. The threshold values can be divided equally (or unequally) into groups, such as a low risk group, a medium risk group and a high-risk group, or into quadrants, the lowest quadrant being individuals with the lowest risk the highest quadrant being individuals with the highest risk, and the test subject's risk of having CVD can be based upon which group his or her test value falls. Threshold values for markers in biological samples obtained, such as mean levels, median levels, or “cut-off” levels, are established by assaying a large sample of individuals in the general population or the select population and using a statistical model such as the predictive value method for selecting a positivity criterion or receiver operator characteristic curve that defines optimum specificity (highest true negative rate) and sensitivity (highest true positive rate) as described in Knapp, R. G., and Miller, M. C. (1992). Clinical Epidemiology and Biostatistics. William and Wilkins, Harual Publishing Co. Malvern, Pa., which is specifically incorporated herein by reference. A “cutoff” value can be determined for each risk predictor that is assayed.

Levels of particular markers in a subject's biological sample may be compared to a single threshold value or to a range of threshold values. If the level of the marker in the test subject's biological sample is greater than the threshold value or exceeds or is in the upper range of threshold values, the test subject may, depending on the marker, be at greater risk of developing or having CVD or experiencing a cardiovascular event within the ensuing year, two years, and/or three years than individuals with levels comparable to or below the threshold value or in the lower range of threshold values. In contrast, if levels of the marker in the test subject's biological sample is below the threshold value or is in the lower range of threshold values, the test subject, depending on the marker, be at a lower risk of developing or having CVD or experiencing a cardiovascular event within the ensuing year, two years, and/or three years than individuals whose levels are comparable to or above the threshold value or exceeding or in the upper range of threshold values. The extent of the difference between the test subject's marker levels and threshold value may also useful for characterizing the extent of the risk and thereby determining which individuals would most greatly benefit from certain aggressive therapies. In those cases, where the threshold value ranges are divided into a plurality of groups, such as the threshold value ranges for individuals at high risk, average risk, and low risk, the comparison involves determining into which group the test subject's level of the relevant marker falls.

### VII. Evaluation of Therapeutic Agents or Therapeutic Interventions

Also provided are methods for evaluating the effect of CVD therapeutic agents, or therapeutic interventions, on individuals who have been diagnosed as having or as being at risk of developing CVD. Such therapeutic agents include, but are not limited to, antibiotics, anti-inflammatory agents, insulin sensitizing agents, antihypertensive agents, anti-thrombotic agents, anti-platelet agents, fibrinolytic agents, lipid reducing agents, direct thrombin inhibitors, ACAT inhibitor, CDTP inhibitor thioglytizone, glycoprotein IIb/IIIa receptor inhibitors, agents directed at raising or altering HDL metabolism such as apoA-I milano or CETP inhibitors (e.g., torcetrapib), agents designed to act as artificial HDL, particular diets, exercise programs, and the use of cardiac related devices. Accordingly, a “CVD therapeutic agent,” as used herein, refers to a broader range of agents that can treat a range of cardiovascular-related conditions, and may encompass more compounds than the traditionally defined class of cardiovascular agents.

Evaluation of the efficacy of CVD therapeutic agents, or therapeutic interventions, can include obtaining a predetermined value of two or three or more markers (e.g. a microalbumin-creatinine ratio (ACR), hs-CRP, Lp-PLA2, an F2-isoprostane, and myeloperoxidase) in a biological sample, and determining the level of two or three or more markers in a corresponding biological fluid taken from the subject following administration of the therapeutic agent or use of the therapeutic intervention. A decrease in the level of one or more markers, depending the marker, in the sample taken after administration of the therapeutic as compared to the level of the selected risk markers in the sample taken before administration of the therapeutic agent (or intervention) may be indicative of a positive effect of the therapeutic agent on cardiovascular disease in the treated subject.

A predetermined value can be based on the levels of two or more markers in a biological sample taken from a subject prior to administration of a therapeutic agent or intervention. In another embodiment, the predetermined value is based on the levels of one or more markers taken from control subjects that are apparently healthy, as defined herein.

Embodiments of the methods described herein can also be useful for determining if and when therapeutic agents (or interventions) that are targeted at preventing CVD or for slowing the progression of CVD should and should not be prescribed for a individual. For example, individuals with marker values above a certain cutoff value, or that are in the higher tertile or quartile of a “normal range,” could be identified as those in need of more aggressive intervention with lipid lowering agents, insulin, life style changes, etc.

### EXAMPLES

### Example 1

### Panel Detection for Improved Diagnosis

This Example describes various human patient case studies that demonstrate the value of testing for a panel of markers in order to improve diagnosis of the risk of cardiovascular disease.

Case study A. A 63-year-old woman was taking estrogen since 1988 for surgically induced menopause. She presented for heart attack and stroke prevention with concern over her “borderline high cholesterol.” She was found to be in excellent health: height, 5 feet 4 inches; weight 121 pounds; waist 26 inches; and BP 120/80. Her lifestyle habits were excellent with diet and daily exercise. She had no known CV disease or symptoms. Her hs-CRP was elevated at 2.9 mg/L and her LDL was 110 mg/L.

She would have qualified in a study for statin therapy. Further testing revealed normal Lp-PLA2 and ACR. In addition, no evidence was found of subclinical atherosclerosis. She had a normal ankle-brachial index, normal ultrasound of the abdominal aorta, normal carotid B-mode ultrasound and a zero score on coronary artery calcification testing. She also was negative for the myocardial infarction gene test. The only abnormality was her hs-CRP, which is known to increase simply with estrogen therapy (Ridker P M et al. Circulation. August,1999;100:713-716). As such, she does not need statin therapy, as the other two more precise inflammatory markers would indicate.

Case study B. A 60-year-old white woman participated in a CV risk assessment offered as part of a wellness screening program. At the time of her initial assessment, she was apparently healthy and asymptomatic. She was a thin nonsmoker with a blood pressure reading of 120/80 and excellent cholesterol values without any treatment (total cholesterol, 161 mg/dL; LDL, 38 mg/dL; HDL, 108 mg/dL; triglyceride, 75 mg/dL). Her Framingham 10-year risk of developing heart disease was low at 1 percent. Lp-PLA2 was very elevated. At the time of her initial screening, this vascular specific biomarker was the only abnormal measurement found. This result brought her for further evaluation to an advanced center for CV prevention.

A carotid B-mode ultrasound evaluation revealed atherosclerosis, with plaque at the bifurcation of the right carotid artery. This documented a definite risk for stroke. She had a family history for strokes and heart attacks, but had always been reassured by her physician that she need not worry since her cholesterol levels were fantastic. It's interesting to note that further evaluation revealed a slightly elevated hs-CRP and fibrinogen. More remarkable was her highly elevated ACR. Her MPO was assessed as a research measurement and was found to be extremely high. The MPO may explain why, despite a life-long remarkably high HDL, she still had atherosclerosis with risk for a stroke.

Case Study C. A 55 year old Caucasian male with known subclinical atherosclerosis being managed for heart attack and or stroke prevention. Therapeutic decisions hinge on maintaining a non-inflammatory state of his arteries. His endothelial inflammation is evaluated by hs-CRP and ACR; his intima status is evaluated by Lp-Pla2; his overall arterial inflammatory state is monitored by MPO. Recent labs: hs-CRP—0.3 mg/L; ACR—12.2 (normal for males is <4.0); Lp-Pla2—137; MPO—352. If one tried to evaluate the inflammatory state with the ACR in isolation, the conclusion would be that the artery is inflamed and the patient is high risk. The entire “fire panel” (hs-CRP, ACR, Lp-P1a2, and MPO) adds value allowing the practitioner to arrive at more accurate clinical conclusions which allows for better management. Since the hs-CRP is very low, the endothelium is not inflamed; ruling that out as a cause for the elevated ACR. Since the MPO is normal, it is unlikely that there are any erosions of the endothelium or dysfunction of the endothelium secondary to severe depletion of nitric oxide; ruling out these possible explanations for the elevated ACR. Since the Lp-Pla2 is normal, it is unlikely that there is a significant proatherogenic state accounting for the elevated ACR. This allows the provider to conclude there is no significant arterial inflammation at the present time which places the patient at very low risk for a CV event. It also calls into question a possible mechanical cause for the elevated ACR as opposed to a metabolic cause. Indeed, his blood pressure has been elevated in the pre-hypertensive range which could account for an increase in the ACR. Over time this would place the patient at increased risk for renal disease. This type of conclusion is only possible with the panel of tests taken as a whole. Looking at any one component of the panel would fail to arrive at such a conclusion. This case clearly illustrates the value of the “fire panel” (hs-CRP, ACR, Lp-Pla2, and MPO) as opposed to the evaluation of each component as isolated entities.

Case Study D. A 76 year old Caucasian female with known subclinical atherosclerosis in numerous vascular beds being managed for heart attack and or stroke prevention. Known higher risk since she has suffered a TIA in the past. Therapeutic decisions hinge on maintaining a non-inflammatory state of her arteries. Her endothelial inflammation is evaluated by hs-CRP and ACR; her intima status is evaluated by Lp-Pla2; her overall arterial inflammatory state is monitored by MPO. Recent labs: hs-CRP—0.3 mg/L; ACR—38.1 (normal for females is <7.5); Lp-Pla2—215 (want<200) MPO—493 (want<480). If one tried to evaluate the inflammatory state with the hs-CRP in isolation, the conclusion would be that the artery is fine and the patient is low risk. The entire “fire panel” (hs-CRP, ACR, Lp-Pla2, and MPO) adds tremendous value allowing the practitioner to arrive at more accurate clinical conclusions which allows for better management. Since the MPO is elevated, the entire artery could be inflamed; ruling out low risk as indicated by the hs-CRP. Since the Lp-Pla2 is abnormal, it is likely that there is a significant proatherogenic state and inflammation of the intimal layer placing the patient at high risk. The ACR is high which could be from endothelial inflammation, but the hs-CRP rules that out as the cause. Therefore, one must conclude that it could be high due to either metabolic dysfunction of the artery or mechanical issues. The MPO and Lp-Pla2 would fit with metabolic dysfunction. Her blood pressure is also too high, so the elevated ACR could be due to a combination of metabolic and mechanical influences. This type of conclusion is only possible with the panel of tests taken as a whole. Looking at any one component of the panel would fail to arrive at such a conclusion. As a matter of fact, if one went by the ‘guidelines’ and simply assessed hs-CRP, this high risk patient would be missed. This case clearly illustrates the important value of the “fire panel” as opposed to the evaluation of each component as isolated entities. It also argues for utilization of the whole panel as individual components viewed in isolation can be dangerously misleading.

Case Study E. A 67 year old Caucasian male with subclinical atherosclerosis was evaluated. Inflammation of the arteries was assessed. The F2-isoprostane, which takes a broad look at oxidative state, was fine/normal. His myeloperoxidase level was fine/normal. His fibrinogen was fine/normal. His hs-CRP was 1.5 which would indicate potential inflammation of the endothelium and his microalbumin-creatinine certainly backs that up being 12.7. In terms of intimal inflammation, his PLAC2 result was 239 indicating he has inflammation there as well. So it appears his endothelium and his intimal layer are inflamed which would actually place him at high risk right now for a cardiovascular event.

Case Study F. A 61 year old Caucasian female with known subclinical atherosclerosis and SLE was evaluated. Testing was done to assess her arterial inflammation. Her F2-Isoprostane level, which is a broad look at the oxidative state, was normal. Her myeloperoxidase was normal. Her fibrinogen was normal. Her hs-CRP was extremely elevated at 44.4, which could be expected from her lupus. Her microalbumin-creatinine ratio was fine/normal at 6.1. So, this would mean that she does not have any endothelial inflammation. Her PLAC2 test was perfectly normal at 176. So it appears she has no arterial inflammation at the present time. This would place her at extremely low risk for a cardiovascular event.

Case Study G. A 63 year old Caucasian female with known subclinical atherosclerosis was evaluated. In terms of arterial inflammation, her CRP was 1.6, but she has some arthritis in her hand which could be driving the CRP up. However, the microalbumin-creatinine ratio is 17.4, so there probably is some inflammation of the endothelium. Her PLAC2 is normal at 172. Unfortunately, her myeloperoxidase has risen to 560, which is now considered elevated. She should currently be considered high risk.

Case Study H. A 75 y.o. male with known CAD and stent was evaluated. He is on treatment for atherosclerosis, hypertension, insulin resistance and lipo(a)—coming in for regular assessment of vascular inflammation. New risk—recent emotional stressors lending to drop in exercise, poor sleep pattern and anxiety.
Oxidative Stress—F2 isoprostane—5.02=suggests poor level—improve lifestyle MPO—333
Endothelial health—hsCRP 1.1 backed up with microal/creat urine—11.5 (increased from last)
Intima health—Lp-PLA2—160—stable

Plan: stress management, increase exercise, work on sleep and the inflammatory panel also suggested that an increase in his pharmacological regime is necessary. The panel was critical—his risk factors (lipids, sugars, pressures) didn't change.

Case Study I. A 77 y.o. female with subclinical atherosclerosis was evaluated. She is on treatment for hyperlipidemia and lipo(a) and she is coming in for regular assessment of vascular inflammation with recent complaints of sore tooth (having dental exam same week).
Oxidative Stress—0.11=suggests good lifestyle modification—exercises daily on stationary bike watches fats and simple carbs, sleeps 8-9 hours/night MPO—423
Endothelial health—hsCRP 1.1 (up from 1.8), microal/creat urine—5.1 (down from 8.2)
Intima health—188 (up from 167)

Plan: get into dentist asap for dental evaluation and oral DNA pathogen testing.

Continue with her current treatment plan. Her Lp-PLA2 and complaints of dental health suggests the possibility of this impacting her vascular inflammation.

Case Study J. A 57 y.o. female with subclinical atherosclerosis—on treatment for hyperlipidemia, insulin resistance, MPO and an Apo E 4/4—coming in for an evaluation—no complaints.
Oxidative stress—<0.1—excellent shape, daily exercise and low fat diet MPO—1169 (down from 1771)
Endothelial health—hsCRP <0.2, microal/creat urine—25.0 (up from 20.0)
Intima health: Lp-PLA2—183 (down from 220)

Plan: because she has persistent inflammation, her medication was increased (Niaspan) and sent for oral DNA testing. Reconfirmed the value of her lifestyle.

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in relevant fields are intended to be within the scope of the following claims.

We claim:

1. A multiplex panel, comprising:
reagents for detecting levels or activity of three or more markers selected from the group consisting of: a microalbumin-creatinine ratio (ACR), hs-CRP, Lp-PLA2, an F2-isoprostane, and myeloperoxidase.

2. The panel of claim 1, further comprising reagents for detecting fibrinogen.

3. The panel of claim 1, further comprising reagents for detecting KIF6.

4. The panel of claim 1, comprising reagents for detecting levels or activity of four or more of said markers.

5. The panel of claim 1, comprising reagents for detecting levels or activity of all of said markers.

6. The panel of claim 1, comprising reagents for detecting levels or activity of a microalbumin-creatinine ratio (ACR), hs-CRP, Lp-PLA2 and myeloperoxidase.

7. The panel of claim 1, wherein said markers are polypeptides and said reagent comprises reagents for detecting levels or activity of said polypeptides.

8. A kit, comprising:
reagents for detecting levels or activity of three or more markers selected from the group consisting of: a microalbumin-creatinine ratio (ACR), hs-CRP, Lp-PLA2, an F2-isoprostane, and myeloperoxidase.

9. The kit of claim 8, further comprising reagents for detecting fibrinogen.

10. The kit of claim 8, further comprising reagents for detecting KIF6.

11. The kit of claim 8, comprising reagents for detecting levels or activity of four or more of said markers.

12. The kit of claim 8, comprising reagents for detecting levels or activity of all of said markers.

13. The kit of claim 8, comprising reagents for detecting levels or activity of a microalbumin-creatinine ratio (ACR), hs-CRP, Lp-PLA2 and myeloperoxidase.

14. The kit of claim 8, wherein said markers are polypeptides and said reagent comprises reagents for detecting levels or activity of said polypeptides.

15. A method for determining risk of a cardiovascular event or complication of a cardiovascular event, comprising:
a) measuring the levels or activity of three or more markers selected from the group consisting of: a microalbumin-creatinine ratio (ACR), hs-CRP, Lp-PLA2, an F2-isoprostane, and myeloperoxidase in a sample from a subject; and
b) determining an increased risk of a cardiac event, or complication of a cardiovascular event, in said subject when levels or activity of one or more of said markers are elevated.

16. The method of claim 15, wherein said subject is apparently healthy.

17. The method of claim 15, further comprising the step of administering a CVD therapeutic agent to a subject identified as having an increased risk of a cardiac event.

18. The method of claim 15, wherein said level or activity of said three or more markers is compared to a threshold control value for each of said three of more markers.

19. The method of claim 15, further comprising measuring levels or activity of fibrinogen.

20. The method of claim 15, further comprising measuring levels or activity of KIF6.

21. The method of claim 15, comprising measuring activity or levels of four or more of said markers.

22. The method of claim 15, comprising measuring activity or levels of all of said markers.

23. The method of claim 15, comprising measuring activity or levels of a microalbumin-creatinine ratio (ACR), hs-CRP, Lp-PLA2 and myeloperoxidase.

24. The method of claim 15, wherein said determining an increased risk is found when said levels or activity or two or more of said markers are elevated.

25. The method of claim 15, wherein said determining an increased risk is found when said levels or activity or three or more of said markers are elevated.
